(19) United States
(12) Patent Application Publication
(10) Pub. No.: US 2026/0234364 A1
(43) Pub. Date: Aug. 13, 2026

(54) INORGANIC FILLER FOR LOW DIELECTRIC LOSS RESIN COMPOSITION, SLURRY COMPOSITION FOR LOW DIELECTRIC LOSS RESIN COMPOSITION, LOW DIELECTRIC LOSS RESIN COMPOSITION, MOLDED PRODUCT FOR HIGH-FREQUENCY EQUIPMENT, AND HIGH-FREQUENCY EQUIPMENT

(71) Applicant: STELLA CHEMIFA CORPORATION, Osaka-shi, Osaka (JP)

(72) Inventors: Keigo Fujiwara, Sakai-shi (JP); Takashi Oono, Sakai-shi (JP); Kazutaka Murakami, Sakai-shi (JP); Rui Hasebe, Sakai-shi (JP); Tetsuo Nishida, Sakai-shi (JP)

(73) Assignee: STELLA CHEMIFA CORPORATION, Osaka-shi, Osaka (JP)

(21) Appl. No.: 19/156,129

(22) PCT Filed: Dec. 27, 2023
(86) PCT No.: PCT/JP2023/047138

§ 371 Date: Aug. 13, 2025

(30) Foreign Application Priority Data
Feb. 14, 2023 (JP) 2023-020687

(51) Int. Cl. C08K 3/16; C01F 7/50

(52) U.S. Cl. CPC C08K 3/16; C01F 7/50; C01P 2002/74; C01P 2004/61; C01P 2004/62; C01P 2004/64; C01P 2006/40; C01P 2006/80; C08K 2003/164; C08K 2201/005; C08K 2201/011

(57) ABSTRACT

An inorganic filler for a low dielectric loss resin composition according to the present invention is in the form of powder form, and contains aluminum fluoride having an α phase. In the inorganic filler for a low dielectric loss resin composition, a half width of a peak on a (012) plane of an α phase of the aluminum fluoride in an X-ray diffraction pattern is 0.3° or less.

### TECHNICAL FIELD

The present invention relates to an inorganic filler for a low dielectric loss resin composition which contains at least a polymer resin and an inorganic filler and can be applied to electronic components such as circuit boards, information communication equipment and the like, a slurry composition for a low dielectric loss resin composition, a low dielectric loss resin composition, a molded product for high-frequency equipment, and high-frequency equipment.

### BACKGROUND ART

Recently, in electronic components such as printed wiring boards, flexible circuit boards and high-frequency boards, information communication equipment, and the like, the frequency of electric signals used has been being increased for communicating high-volume data at a high speed.

In particular, in electronic components and the like for high-frequency uses, an increased frequency may lead to an increase in attenuation of electric signals by a transmission loss of a transmission path, resulting in deterioration of transmission reliability. Therefore, for high-frequency equipment, components thereof, and the like, materials are required in which a value of a loss coefficient that is a factor of a transmission loss, other than α frequency, is small. Here, the loss coefficient is obtained as a product of a value of a square root of a relative permittivity (εᵣ) and a value of a dielectric loss tangent (tan δ).

For example, Patent Document 1 discloses a thermosetting resin composition containing, as essential components, (A) a polyimide resin having a carboxyl group or an acid anhydride group and having a linear hydrocarbon structure with a number average molecular weight of 300 to 6,000, (B) an epoxy resin, (C) an organic solvent having a boiling point of 100° C. or higher, and spherical silica, which is intended to reduce the relative permittivity and the dielectric loss tangent of a multi-layer printed board. Patent Document 1 indicates that it is possible to form an interlayer insulating resin layer having sufficient adhesion with a conductor, high heat resistance, flame retardancy, a low dielectric constant, a low dielectric loss tangent, and a low water absorption coefficient.

Patent Document 2 discloses an inorganic filler on which surface modification is performed by sequentially introducing amine groups having excellent compatibility and reactivity with an alkyl group and an epoxy resin. Patent Document 2 indicates that low dielectric loss factor characteristics can be imparted by producing an epoxy resin composition using the surface-modified inorganic filler.

Patent Document 3 discloses a surface-treated metal oxide particle material including a metal oxide particle material and a polyorganosiloxane compound for surface treatment of the metal oxide particle material. Patent Document 3 indicates that the inclusion of the surface-treated metal oxide particle material in the resin material can suppress the viscosity of the resulting resin composition, and the relative permittivity and the dielectric loss tangent of the resin composition.

However, the technique disclosed in Patent Document 1 controls the low dielectric loss characteristics of a resin composition itself. The techniques disclosed in Patent Documents 2 and 3 control the low dielectric loss of the resin composition by performing surface modification on an inorganic filler. That is, the techniques disclosed in Patent Documents 1 to 3 do not enhance or improve the low dielectric loss of the resin composition by using an inorganic filler having excellent low dielectric loss characteristics.

### PRIOR ART DOCUMENT

### Patent Document

Patent Document 1: JP 5,564,012
Patent Document 2: JP-A-2015-67534
Patent Document 3: JP-A-2020-66678

### SUMMARY OF THE INVENTION

### Problems to be Solved by the Invention

An object of the present invention is to provide a novel inorganic filler for a low dielectric loss resin composition, which suppresses a loss coefficient in a high-frequency band and has good low dielectric loss characteristics, a slurry composition for a low dielectric loss resin composition, a low dielectric loss resin composition, a molded product for high-frequency equipment, and high-frequency equipment.

### Solutions to the Problems

In order to solve the above problem, an inorganic filler for a low dielectric loss resin composition according to the present invention is an inorganic filler for a low dielectric loss resin composition, wherein the inorganic filler is in a powder form, and contains aluminum fluoride having an α phase, and a half-width of a peak on a (012) plane of an α phase of the aluminum fluoride in an X-ray diffraction pattern is 0.3° or less.

In the above configuration, it is preferred that the half-width is 0.120 or more.

Moreover, in the above configuration, it is preferred that an average particle size D50 of the inorganic filler is 0.05 μm or more and 75 μm or less.

Furthermore, in the above configuration, it is preferred that an oxygen content of the inorganic filler is 2 mass % or less with respect to a total mass of the inorganic filler.

In order to solve the above problem, a slurry composition for a low dielectric loss resin composition according to the present invention is a slurry composition for a low dielectric loss resin composition in which an inorganic filler is dispersed in a solvent, wherein the inorganic filler contains aluminum fluoride having an α phase, and a half-width of a peak on a (012) plane of an α phase of the aluminum fluoride in an X-ray diffraction pattern is 0.3° or less.

In the above configuration, it is preferred that the half-width is 0.120 or more.

Moreover, in the above configuration, it is preferred that an average particle size D50 of the inorganic filler is 0.05 μm or more and 75 μm or less.

Furthermore, in the above configuration, it is preferred that an oxygen content of the inorganic filler is 2 mass % or less with respect to a total mass of the inorganic filler.

Furthermore, in the above configuration, it is preferred that a content of the inorganic filler is 1 mass % or more and 85 mass % or less with respect to a total mass of the slurry composition for a low dielectric loss resin composition.

In order to solve the above problem, a low dielectric loss resin composition according to the present invention is a low dielectric loss resin composition comprising at least a polymer resin and an inorganic filler, wherein the inorganic filler contains aluminum fluoride having an α phase, and a half-width of a peak on a (012) plane of an α phase of the aluminum fluoride in an X-ray diffraction pattern is 0.3° or less.

In the above configuration, it is preferred that the half-width is 0.12° or more.

Moreover, in the above configuration, it is preferred that an average particle size D50 of the inorganic filler is 0.05 μm or more and 75 μm or less.

Furthermore, in the above configuration, it is preferred that an oxygen content of the inorganic filler is 2 mass % or less with respect to a total mass of the inorganic filler.

Furthermore, in the above configuration, it is preferred that a content of the inorganic filler is 1 mass % or more and 85 mass % or less with respect to a total mass of the low dielectric loss resin composition.

In the above configuration, it is preferred that the polymer resin contains at least one thermoplastic resin and/or at least one thermosetting resin.

In the above configuration, it is preferred that the polymer resin is at least one selected from a group consisting of olefin-based resin, polycarbonate resin, polyphenylene ether resin, polysulfone resin, polyethersulfone resin, polyphenylene sulfide resin, polyether ether ketone resin, liquid crystal polymer resin, polyimide resin, fluororesin, phenol resin, epoxy resin, silicone resin, and a modified product thereof.

In order to solve the above problem, a molded product for high-frequency equipment according to the present invention is a molded product for high-frequency equipment used in a frequency band of 1 GHz or more, the molded product comprising a molded product containing the low dielectric loss resin composition.

In order to solve the above problem, high-frequency equipment according to the present invention is high-frequency equipment used in a frequency band of 1 GHz or more, the high-frequency equipment comprising the low dielectric loss resin composition.

Moreover, in order to solve the above problem, high-frequency equipment according to the present invention is high-frequency equipment used in a frequency band of 1 GHz or more, the high-frequency equipment comprising the molded product for high-frequency equipment.

### Effects of the Invention

According to the present invention, by using, for a low dielectric loss resin composition, an inorganic filler containing aluminum fluoride (AlF₃) which has an α phase and in which the half-width of a peak on the (012) plane of the α phase in an X-ray diffraction pattern is 0.3° or less, or a slurry for a low dielectric loss resin composition in which the inorganic filler is dispersed in a solvent, the loss coefficient in a high-frequency band can be reduced, and low dielectric loss characteristics can be improved. As a result, for example, even when the low dielectric loss resin composition containing the inorganic filler of the present invention is molded into a film-shaped or sheet-shaped molded article, and used for electronic components such as printed wiring boards, flexible circuit boards and high-frequency boards that have a reduced thickness, it is possible to prevent deterioration of electrical characteristics which is caused by surface irregularities.

Further, according to the present invention, by using the low dielectric loss resin composition of the present invention for a molded product for high-frequency equipment or high-frequency equipment, attenuation of electric signals by a transmission loss is suppressed to enable transmission at a high speed and a high frequency even in the case of use in a high-frequency band of 1 GHz or more.

### EMBODIMENTS OF THE INVENTION

### (Inorganic Filler for Low Dielectric Loss Resin Composition)

First, an inorganic filler for a low dielectric loss resin composition according to an embodiment of the present invention (hereinafter, referred to as an “inorganic filler”) will be described below.

The inorganic filler of the present embodiment is a powdered solid particle, and contains crystalline aluminum fluoride having an α phase (hereinafter, referred to simply as “aluminum fluoride”) as a main component. In the present invention, aluminum fluoride has been found to exhibit excellent low dielectric loss characteristics, for example, in a high-frequency band of 1 GHz or more, and is included as a constituent component of a low dielectric loss resin composition (which will be described in detail later) to achieve a marked effect of improving the low dielectric loss characteristics of the low dielectric loss resin composition.

In the aluminum fluoride of the present embodiment, the half-width of a peak on the (012) plane of an α phase in an X-ray diffraction pattern is 0.3° or less, preferably 0.25° or less, and more preferably 0.2°. In general, an average particle size of an inorganic compound decreases, the proportion of the surface layer to the entire particle increases. Since the energy state of the particle surface is higher than that of the interior, making it prone to structural disorder and reducing crystallinity. For this reason, the physical and chemical properties derived from the bulk change from original properties, and the dielectric loss tangent tends to increase at a particle surface. Therefore, it is desirable that the crystallinity be high regardless of the average particle size of the inorganic compound. Here, in the present invention, the degree of crystallinity can be evaluated by the half-width of an X-ray diffraction peak of the (012) plane derived from aluminum fluoride. In general, a decreased value of the half-width leads to increased crystallinity, reduced fluctuation of the crystal structure, and hence a decreased dielectric loss tangent. Therefore, the crystallinity of aluminum fluoride can also be increased by reducing the half-width of a peak on the (012) plane in the X-ray diffraction pattern. Based on this point of view, in the present invention, the upper limit value of half-width is set to 0.3° or less to suppress the dielectric loss tangent while inhibiting the crystallinity of aluminum fluoride from becoming excessively high, so that the loss coefficient can be reduced, and the low dielectric loss can be suppressed.

The lower limit of the half-width is preferably 0.120 or more, and more preferably 0.15° or more. By setting the lower limit value of the half-width to 0.12° or more, the grain size of crystal grains can be prevented from becoming excessively large due to excessive growth of the crystal grains in crystallization of amorphous aluminum fluoride or in crystal growth. By this, an increase in average particle size D50 of aluminum fluoride is prevented, and the crystallinity of aluminum fluoride can be inhibited from becoming excessively high. As a result, when the inorganic filler of the present embodiment is applied to a low dielectric loss resin composition, which is made into a film-shaped or sheet-shaped molded article, irregularities on the surface can be reduced or suppressed to prevent deterioration of electrical characteristics even in the case of use for electronic components such as printed wiring boards, flexible circuit boards and high-frequency boards that have a reduced thickness. In addition, it is possible to produce a film-shaped or sheet-shaped molded article whose thickness is sufficiently suppressed.

The term “half-width” as used herein means a full-width at half maximum. The term “X-ray diffraction pattern” refers to a plot line of diffraction intensity measured at each incidence angle in a two-dimensional graph with the incident angle on the horizontal axis and the diffraction intensity on the vertical axis in sample measurement performed by (powder) X-ray diffraction. The term “(012) plane of an α phase of aluminum fluoride in an X-ray diffraction pattern”, which is an orientation plane of a crystal of aluminum fluoride, means the (012) plane of the α phase in the X-ray diffraction pattern. The peak of the diffraction on the (012) plane of the α phase of aluminum fluoride is positioned around 25.3° on 20.

The inorganic filler of the present embodiment may contain other known inorganic fillers as long as the effects of the present invention are not impaired, or may be composed only of aluminum fluoride having an α phase. The other inorganic filler is not particularly limited, and examples thereof include silica, alumina, barium sulfate, talc, clay, mica powder, zirconium hydroxide, magnesium hydroxide, calcium carbonate, magnesium carbonate, magnesium oxide, boron nitride, zirconium borate, barium titanate, calcium titanate, magnesium titanate, bismuth titanate, titanium oxide, barium zirconate, calcium zirconate, and fluorine compounds. As the other inorganic filler, fibrous fillers such as paper, glass nonwoven fabric, synthetic fiber, cellulose fiber, carbon fiber, and carbon nanotube can also be used without being limited to, for example, the shape of the low dielectric loss resin composition.

The content of the other inorganic filler is not particularly limited, and can be appropriately set according to a use, a purpose, and the like.

The upper limit value of the relative permittivity εᵣ₁[-] of the inorganic filler is preferably 6 or less, more preferably 4 or less, and particularly preferably 3.5 or less at a frequency of 1 GHz or more and a temperature of 25° C. When the relative permittivity εᵣ₁ of the inorganic filler is 6 or less, the loss coefficient can be reduced, and the low dielectric loss can be suppressed.

The upper limit value of the dielectric loss tangent tan δ₁[-] of the inorganic filler is preferably 0.008 or less, more preferably 0.005 or less, still more preferably 0.002 or less, and particularly preferably 0.001 or less at a frequency of 1 GHz or more and a temperature of 25° C. When the dielectric loss tangent tan δ₁ of the inorganic filler is 0.008 or less, the loss coefficient can be reduced, and the low dielectric loss can be suppressed.

The upper limit value of the loss coefficient of the inorganic filler is preferably less than 15, more preferably 10 or less, still more preferably 8 or less, and particularly preferably 5 or less. When the loss coefficient is less than 15, the loss coefficient of the low dielectric loss resin composition can be reduced, and the low dielectric loss characteristics can be improved.

The numerical values of the relative permittivity εᵣ₁ and the dielectric loss tangent tan δ₁ for use in quantification of the dielectric characteristics and the dielectric loss are based on a value obtained by measuring the powdery inorganic filler and converting the measured value. Measurement methods can be appropriately selected. Specifically, measurements can be made by the methods described in Examples below.

For the loss coefficient, the value of the loss coefficient can be calculated on the basis of the following expression using the measured values of a relative permittivity εᵣ₁ and a dielectric loss tangent tan δ₁ of a powdery inorganic filler.

$$( Loss coefficient ) = {( {ε}_{r 1} )}^{1 / 2} \times tan {δ}_{1} \times {10}^{3}$$

wherein εᵣ₁[-] represents a relative permittivity of a powdery inorganic filler used in the measurement, and tan δ₁[-] represents a dielectric loss tangent of the inorganic filler.

The relative permittivity εᵣ₁ is a parameter indicating a degree of polarization of the inorganic filler used in measurement, and the higher the relative permittivity, the larger the propagation delay of electric signals. Therefore, the relative permittivity is preferably low from the viewpoint of increasing the propagation speed of signals. The dielectric loss tangent tan δ₁ is a parameter indicating an amount in which signals propagating through the inside of the inorganic filler used in the measurement are lost by conversion into heat, and a decreased dielectric loss tangent leads to a reduced loss of signals, and an improved signal transmissibility.

The average particle size D50 (particle size corresponding to the cumulative frequency of 50% in a cumulative particle size distribution on a volume basis) of the inorganic filler is not particularly limited, and can be appropriately set according to, for example, a shape of a molded article containing a low dielectric loss resin composition, which includes a size, a thickness and the like of the article, and a reason such as adjustment of the fluidity of a material containing the inorganic filler in preparation of the low dielectric loss resin composition. Normally, the upper limit value of the average particle size D50 of the inorganic filler is preferably 75 μm or less, more preferably 50 μm or less, still more preferably 10 μm or less, and particularly preferably 1 μm or less. On the other hand, the lower limit value of the average particle size D50 of the inorganic filler is preferably 0.05 μm or more, more preferably 0.075 μm or more, and still more preferably 0.1 μm or more. If the average particle size D50 of the inorganic filler is excessively large, it is difficult to make the surface of the molded article flat in the case of application to a film-shaped or sheet-shaped molded article. As a result, for example, in formation of a laminate, the electrical characteristics of the laminate may be impaired by irregularities on the surface of the molded article. On the other hand, if the average particle size D50 of the inorganic filler is excessively small, uniform mixing is difficult in mixing of the inorganic filler with a polymer resin (which will be described in detail later), and the viscosity of the mixture may increase to an extent that it is difficult to mold the low dielectric loss resin composition.

When the low dielectric loss resin composition of the present embodiment is a film-shaped or sheet-shaped molded article, the average particle size D50 of the inorganic filler is preferably set to ⅕ or less, more preferably 1/10 or less of the thickness of the molded article within the above-described numerical range. For example, when the molded article of the low dielectric loss resin composition is in the form of a film or a sheet having a thickness of about 20 μm, the average particle size D50 of the inorganic filler is preferably 10 μm or less, more preferably 2 μm or less, and still more preferably 1 μm or less. By this, a film-shaped or sheet-shaped molded article can be formed with the inorganic filler particles aligned in the form of a single layer. As a result, a molded article with reduced or prevented surface irregularities can be obtained. In a slurry composition before curing in which the inorganic filler is dispersed in the solvent (which will be described in detail later), sedimentation of the inorganic filler is suppressed, so that it is possible to obtain a film-shaped or sheet-shaped molded article which is uniformly filled with the inorganic filler.

The average particle size D50 of the inorganic filler is a value obtained by measurement using, for example, a laser diffraction and scattering method with Microtrac MT3300EXII (trade name: manufactured by Nikkiso Co., Ltd.).

The oxygen content of the inorganic filler is preferably 2 mass % or less, more preferably 1.5 mass % or less, and still more preferably 1 mass % or less with respect to the total mass of the inorganic filler. The content of oxygen atom-containing components (for example, surface hydroxyl groups, adsorbed moisture, and oxides and oxyfluorides as impurities) contained in the inorganic filler can be reduced, and influences on the dielectric characteristics can be suppressed. More specifically, the crystallinity of aluminum fluoride can be improved by reducing the content of oxygen atom-containing components as impurities. The insulation quality of the inorganic filler can also be improved by reducing the content of oxyfluorides as oxygen atom-containing components. Further, deterioration of dielectric characteristics can also be suppressed by reducing hydroxyl groups and absorbed moisture which are oxygen atom-containing components having a high polarizability.

The oxygen content of the inorganic filler can be measured by using, for example, an X-ray fluorescence spectrometer (trade name: ZSX Primus II, manufactured by Rigaku Corporation).

The shape of the inorganic filler is not particularly limited, and is appropriately selected considering, for example, the fluidity of a slurry composition in which the inorganic filler is dispersed in a solvent or a mixture obtained by mixing the inorganic filler with a polymer resin. In addition, the shape of the inorganic filler can be appropriately selected according to a purpose such as mechanical strength, thermal conductivity, gas diffusibility and the like of a molded article containing the low dielectric loss resin composition.

An inorganic filler having any shape, specific examples of which include a spherical shape, a substantially spherical shape, an elliptical shape, a rod shape, a needle shape, a spindle shape and a plate shape, can be used. In addition, the inorganic filler may be an inorganic filler which has any of these shapes, and may be in a hollow form where a space is provided inside. Further, the inorganic filler of the present embodiment may contain inorganic fillers having the same shape, or two or more inorganic fillers having different shapes.

For the inorganic filler of the present embodiment, it is preferable to use an inorganic filler in which the decrease in mass after heat treatment at, for example, 400° C. or higher is 2 mass % or less, more preferably 1.5 mass % or less, and still more preferably 1 mass % or less, of the mass of the inorganic filler before the heat treatment. By using an inorganic filler in which the decrease after the heat treatment is 2 mass % or less, the low dielectric loss characteristics, the mechanical strength and the like of the low dielectric loss resin composition can be prevented from being deteriorated by generation in polymerization of monomers for forming a polymer resin, release of gas from impurities and heat decomposition of a main component of the polymer resin in heat treatment, and the like. The method for reducing the amount of the decrease after the heat treatment to 2 mass % or less in the inorganic filler is not particularly limited, and examples thereof include materials that are contained in the inorganic filler and that have a high thermal decomposition temperature or do not undergo a phase change in heating, and impurities that cause mass reduction during the synthesis of inorganic fillers, can be removed or reduced in advance by heat treatment or chemical treatment.

Next, a method for producing aluminum fluoride that is contained in the inorganic filler will be described below. The production method described below is illustrative, and the present invention is not limited to this production method.

The method for producing aluminum fluoride includes at least the steps of preparing a slurry of aluminum fluoride by reacting an aluminum salt and fluorine ions and/or ammonium ions, performing solid-liquid separation on the slurry of aluminum fluoride, followed by washing, and preparing a dry solid of aluminum fluoride by removing moisture and a solvent from a paste of aluminum fluoride after the washing.

The reaction between an aluminum salt and fluorine ions and/or ammonium ions in the step of preparing a slurry of aluminum fluoride can be carried out, for example, by adding a solid aluminum salt to a solution containing a fluoride and/or an ammonium compound (hereinafter, referred to as a “solution of fluoride and the like”). The reaction may be carried out by mixing an aluminum salt solution and a solution of fluoride and the like. The aluminum salt solution or the solution of fluoride and the like is preferably filtered to remove foreign matter before being used for the reaction.

The aluminum salt is not particularly limited, and examples thereof include aluminum chloride, aluminum sulfate, aluminum acetate, aluminum nitrate, and aluminum hydroxide. These aluminum salts can be used alone or in a mixture of two or more thereof.

The solvent in the aluminum salt solution is not particularly limited, and examples thereof include water, methanol, ethanol, propanol, isopropyl alcohol, ethylene glycol, propylene glycol, and glycerin. These solvents can be used alone or in a mixture of two or more thereof.

The aluminum salt solution is obtained by dissolving an aluminum salt in a solvent. The temperature of the solvent in dissolution of the aluminum salt in the solvent can be appropriately set according to, for example, a solubility of the aluminum salt in the solvent. For example, when the aluminum salt exhibits sufficient solubility in the solvent at room temperature, the aluminum salt may be dissolved in the solvent at room temperature. When the solubility of the aluminum salt in the solvent is low at room temperature, the aluminum salt may be dissolved after the solvent is heated. By this, the time required for the aluminum salt to dissolve in the solvent can be reduced.

The fluoride and the ammonium compound in the solution of fluoride and the like are not particularly limited, and examples thereof include solutions of ammonium fluoride, acidic ammonium fluoride, sodium fluoride, potassium fluoride, alkylammonium fluoride, ammonium chloride, ammonium sulfate, ammonium nitrate, hydrogen fluoride and the like. These solutions can be used alone or in a mixture of two or more thereof.

The solvent in the solution of fluoride and the like is not particularly limited, and examples thereof include water, organic solvents such as alcohol, and mixed solvents thereof.

The solution of fluoride and the like can be prepared by dissolving a fluoride and/or an ammonium compound in a solvent.

The temperature of the reaction between the solid aluminum salt or the aluminum salt solution and the solution of fluoride and the like is not particularly limited. Normally, the lower limit value and the upper limit value of the temperature are 20° C. or more and 50° C. or less, respectively. Preferably, the lower limit value and the upper limit value of the temperature are 25° C. or more and 45° C. or less, respectively. When the reaction temperature is 20° C. or higher, the pace at which the reaction of the solid aluminum salt or the aluminum salt solution and the solution of fluoride and the like proceeds can be inhibited from becoming excessively low. On the other hand, when the reaction temperature is 50° C. or lower, it is possible to prevent volatilization of some components from the solid aluminum salt and the aluminum salt solution, and the solution of fluoride and the like, which changes the concentrations of the solutions and the like.

When the solid aluminum salt is added to the solution of fluoride and the like, or the aluminum salt solution and the solution of fluoride and the like are mixed, the reaction between the aluminum salt and fluorine ions and/or ammonium ions rapidly proceeds, and aluminum fluoride such as ammonium fluoroaluminate is formed and precipitated to obtain a slurry of aluminum fluoride. For precipitating a larger amount of aluminum fluoride, the aluminum salt solution or the solution of fluoride and the like may be concentrated by a method such as heating or pressure reduction, or a poor solvent may be added. Here, the poor solvent is not particularly limited, and examples thereof include alcohol solutions such as methanol, ethanol and propanol, and mixed solutions of an alcohol solution and water.

Drying treatment may be performed on the slurry of aluminum fluoride which is obtained in the present step. In this case, the drying method is not particularly limited, and examples thereof include natural drying and hot air drying. Drying conditions such as a drying temperature and a drying time are not particularly limited, and can be appropriately set.

The method for solid-liquid separation of the slurry of aluminum fluoride is not particularly limited, and examples thereof include suction filtration, centrifugal dehydration, and pressure filtration. However, a centrifuge may be used if the aluminum fluoride is fine with its average particle size being small, so that it is difficult to perform solid-liquid separation by suction filtration, centrifugal dehydration or pressure filtration. The slurry of aluminum fluoride itself may be made to evaporate to dryness.

Further, the method for washing the paste of aluminum fluoride which is obtained by solid-liquid separation is not particularly limited, and examples thereof include water washing. By this, unreacted fluoride and other anions can be removed from the paste of aluminum fluoride. The washing temperature and the washing time are not particularly limited, and can be appropriately set as necessary.

Examples of the method for removing moisture and a solvent (for example, a hydrous alcohol content or an ammonium component) from the paste of aluminum fluoride after the washing include heating treatment. By this, dry powder of aluminum fluoride can be obtained. The heat treatment method is not particularly limited, and examples thereof include a method in which the paste of aluminum fluoride is placed in a tray, and dried in a drying machine.

The heating temperature during the heating treatment is preferably within the range of 100° C. to 600° C., and more preferably within the range of 400° C. to 600° C. When the heating temperature is 100° C. or higher, moisture and an ammonium component contained in the paste of aluminum fluoride can be sufficiently removed or reduced. On the other hand, when the heating temperature is 600° C. or lower, heat fusion of the aluminum fluorides and heat decomposition can be prevented.

The heating time in the heating treatment is preferably within the range of 1 hour to 48 hours, and more preferably within the range of 3 hours to 24 hours. When the heating time is 3 hours or more, moisture and an ammonium component contained in the paste of aluminum fluoride can be sufficiently removed or reduced. On the other hand, when the heating time is 48 hours or less, heat fusion of the aluminum fluorides and heat decomposition can be prevented.

The heating treatment may be performed in the air or in an inert gas environment. The inert gas is not particularly limited, and examples thereof include nitrogen and argon. From the viewpoint of promoting drying of the paste of aluminum fluoride, for example, heat treatment may be performed in a reduced-pressure environment. There are no particular restrictions on the degree of pressure reduction, and it is normally preferable to maintain the pressure in the range of 10⁻⁵ Pa to 10⁻² Pa using a dry pump, an oil-sealed rotary pump, or the like.

Thus, aluminum fluoride that is contained in the inorganic filler of the present embodiment can be produced.

The average particle size of the obtained aluminum fluoride can be adjusted by, for example, pulverizing aluminum fluoride using a known pulverizing method or the like. The pulverizing method is not particularly limited, and examples thereof include a dry method or a wet method using a pulverizing apparatus such as a bead mill or a jet mill. The pulverizing method may be appropriately selected considering the particle size level, the purity and the like of aluminum fluoride.

In the process of producing aluminum fluoride, the half-width, the average particle size and the shape can also be controlled. For example, by appropriately changing the temperature of the reaction between the aluminum salt and fluorine ions and/or ammonium ions in the process of preparing a slurry of aluminum fluoride, the environment for crystal growth of the aluminum fluoride and the degree thereof can be adjusted to control the half-width, the average particle size and the shape of the aluminum fluoride. The control can also be performed by appropriately adjusting the concentrations of the aluminum salt and fluorine ions. By promoting the crystal growth, the crystallinity can be improved to reduce the half-width. Further, the half-width, the average particle size, and the shape of aluminum fluoride can be controlled by conducting a step of post-treatment such as heat treatment after the step of preparing a dry solid of aluminum fluoride. When the heat treatment is performed, the heating temperature is not particularly limited as long as at least aluminum fluoride having an α phase can be obtained. More specifically, the heating temperature is 510° C. or higher, preferably 640° C. or higher, and more preferably 720° C. or higher. The heating time is not particularly limited as long as at least aluminum fluoride having an α phase can be obtained. More specifically, the heating time is 5 hours or more, preferably 10 hours or more, and more preferably 23 hours or more. For example, by setting the heating temperature to 510° C. or higher and the heating time to 23 hours or longer, production of aluminum fluoride having a R phase can be suppressed. Considering factors such as particle growth due to heat treatment, the heating temperature and the heating time are not particularly limited as long as at least aluminum fluoride having an α phase is obtained, and can be adjusted as appropriate within the above-described numerical ranges.

### (Slurry Composition for Low Dielectric Loss Resin Composition)

Next, a slurry composition for a low dielectric loss resin composition of the present embodiment (hereinafter, referred to as a “slurry composition”) will be described below.

The slurry composition of the present embodiment contains at least the inorganic filler and a solvent. The slurry composition is a dispersion in which an inorganic filler is dispersed (including being floated and suspended) in a solvent. As used herein, the term “dispersion” means a state in which an inorganic filler is dispersed as a dispersoid in a solvent that is a dispersion medium. However, the “dispersion” does not include a solid colloid (organogel) which has no fluidity with a dispersoid dispersed in a solid dispersion medium.

The lower limit value of the content of the inorganic filler is preferably 1 mass % or more, more preferably 10 mass % or more, and particularly preferably 20 mass % or more with respect to the total mass of the slurry composition. On the other hand, the upper limit value of the content of the inorganic filler is preferably 85 mass % or less, more preferably 82 mass % or less, and particularly preferably 79 mass % or less with respect to the total mass of the slurry composition. When the lower limit value of the content of the inorganic filler is 1 mass % or more, the loss coefficient of the slurry composition decreases, so that the low dielectric loss characteristics can be improved.

The relative permittivity, the dielectric loss tangent and the shape of the inorganic filler are as described above. Therefore, detailed descriptions thereof will be omitted.

The solvent is preferably a linear alkane, and more preferably a linear alkane having 10 or more and 16 or less carbon atoms. More specific examples of the linear alkane include n-decane, n-tetradecane, and n-hexadecane. These solvents can be used alone or in a mixture of two or more thereof. Of these linear alkanes, n-hexadecane is particularly preferable because it is liquid at ordinary temperature (for example, 5° C. to 35° C.) and has low polarity among linear alkanes, and from the viewpoint of evaluation of dielectric characteristics. A linear alkane with 10 or more carbon atoms has a low dielectric constant and dielectric loss tangent due to their low polarity, and is hardly soluble in water. The linear alkane has a high boiling point, and thus can be inhibited from undergoing a change in concentration due to volatilization unlike hexane which has a low boiling point. On the other hand, in the case of a linear alkane having 16 or less carbon atoms, the melting point can be reduced 20° C. or lower, and thus deterioration of handleability due to existence in a solid form at ordinary temperature can be prevented. The range of the number of carbon atoms in the present specification means that the range includes all integer numbers of carbon atoms which fall within the range. Therefore, for example, the linear alkane having “10 or more and 16 or less carbon atoms” means all of linear alkanes having 10, 11, 12, 13, 14, 15 and 16 carbon atoms.

The lower limit value of the content of the solvent is preferably 1 mass % or more, more preferably 5 mass % or more, and particularly preferably 15 mass % or more with respect to the total mass of the slurry composition. On the other hand, the upper limit value of the content of the solvent is preferably 99 mass % or less, more preferably 90 mass % or less, and particularly preferably 80 mass % or less with respect to the total mass of the slurry composition.

The upper limit value of the relative permittivity εᵣ₂[-] of the slurry composition is preferably 6 or less, more preferably 4 or less, and particularly preferably 3 or less at a frequency of 1 GHz or more and a temperature of 25° C. When the relative permittivity εᵣ₂ of the slurry composition is 6 or less, the loss coefficient can be reduced, and the low dielectric loss can be suppressed.

The upper limit value of the dielectric loss tangent tan δ₂[-] of the slurry composition is preferably 0.005 or less, more preferably 0.004 or less, still more preferably 0.003 or less, and particularly preferably 0.002 or less at a frequency of 1 GHz or more and a temperature of 25° C. When the dielectric loss tangent tan δ₂ of the slurry composition is 0.005 or less, the loss coefficient can be reduced, and the low dielectric loss can be suppressed.

The upper limit value of the loss coefficient of the slurry composition is preferably less than 6, more preferably 4 or less, and particularly preferably 3 or less. When the loss coefficient is less than 6, the loss coefficient of the slurry composition can be reduced, and the low dielectric loss characteristics can be improved.

The numerical values of the relative permittivity εᵣ₂ and the dielectric loss tangent tan δ₂ for use in quantification of the dielectric characteristics and the dielectric loss are based on a value obtained by measuring the slurry composition and converting the measured value. Measurement methods can be appropriately selected. Specifically, measurements can be made by the methods described in Examples below.

For the loss coefficient, the value of the loss coefficient can be calculated on the basis of the following expression using the measured values of a relative permittivity εᵣ₂ and a dielectric loss tangent tan δ₂ of a slurry composition.

$$( Loss coefficient ) = {( {ε}_{r 2} )}^{1 / 2} \times tan {δ}_{2} \times {10}^{3}$$

wherein εᵣ₂[-] represents a relative permittivity of a slurry composition used in the measurement, and tan δ₂[-] represents a dielectric loss tangent of the slurry composition.

The relative permittivity εᵣ₂ is a parameter indicating a degree of polarization of the slurry composition used in measurement, and the higher the relative permittivity, the larger the propagation delay of electric signals. Therefore, the relative permittivity is preferably low from the viewpoint of increasing the propagation speed of signals. The dielectric loss tangent tan δ₂ is a parameter indicating an amount in which signals propagating through the inside of the slurry composition used in the measurement are lost by conversion into heat, and a decreased dielectric loss tangent leads to a reduced loss of signals, and an improved signal transmissibility.

The slurry composition of the present embodiment may contain other additives as long as the purpose of the present invention is not contradicted. The other additives are not particularly limited, and examples thereof include an ultraviolet inhibitor, a colorant, a flame retardant, a stabilizer, and a dispersant. The content of the other additives is not particularly limited, and can be appropriately set according to a use, a purpose, and the like.

The method for producing the slurry composition of the present embodiment is not particularly limited, and the slurry composition of the present embodiment can be produced by adding a predetermined amount of an inorganic filler to a solvent and stirring the mixture for a predetermined time.

### (Low Dielectric Loss Resin Composition)

Next, a low dielectric loss resin composition of the present embodiment will be described below.

The low dielectric loss resin composition of the present embodiment contains at least the inorganic filler and a polymer resin.

Surface treatment (surface modification) may be performed on the inorganic filler for the purpose of, for example, improving wettability to a polymer resin, improving dispersibility in a polymer resin, improving processability during and after formation of a molded article containing a low dielectric loss resin composition, improving adhesion to a polymer resin and the mechanical strength of a low dielectric loss resin composition, suppressing or preventing moisture absorption and oxidation by an inorganic filler, preventing charging in handling of an inorganic filler, preventing aggregation of an inorganic filler, and adjusting coloration and the refractive index according to a use.

Specific examples of the surface modifier that can be used for surface modification of the inorganic filler include high-molecular surface modifiers such as fatty acids such as stearic acid, oleic acid and linoleic acid; surfactants of, for example, anionic, cationic and nonionic types; coupling agents of, for example, phosphoric acid type, silane type and carboxylic acid type; maleic acid-modified polypropylene; and titanate-based coupling agents. Of these surface modifiers, coupling agents of, for example, phosphoric acid type, silane type and carboxylic acid type coupling agents are preferably used from the viewpoint of improving wettability to a polymer resin and dispersibility of the inorganic filler in a polymer resin.

The lower limit value of the content of the inorganic filler is preferably 1 mass % or more, more preferably 10 mass % or more, and particularly preferably 20 mass % or more with respect to the total mass of the low dielectric loss resin composition. On the other hand, the upper limit value of the content of the inorganic filler is preferably 85 mass % or less, more preferably 82 mass % or less, and particularly preferably 79 mass % or less with respect to the total mass of the low dielectric loss resin composition. When the lower limit value of the content of the inorganic filler is 1 mass % or more, the loss coefficient of the low dielectric loss resin composition decreases, so that the low dielectric loss characteristics can be improved. On the other hand, when the upper limit value of the content of the inorganic filler is 85 mass % or less, deterioration of physical strength such as brittleness can be prevented, and it is possible to improve hardness, reduce the thermal expansion coefficient, and improve weather resistance.

The polymer resin preferably contains at least one thermoplastic resin and/or at least one thermosetting resin.

More specific examples of the polymer resin include olefin-based resins such as polyethylene resin and polypropylene resin; polycarbonate resin; polyphenylene ether resin; polysulfone resin; polyether sulfone resin; polyphenylene sulfide resin; polyether ether ketone resin; liquid crystal polymer resin; polyimide resin; fluororesins such as polytetrafluoroethylene resin (PTFE), a copolymer of polytetrafluoroethylene and perfluoroalkoxyethylene (PFA), polychlorotrifluoroethylene resin (PCTFE), a tetrafluoroethylene-hexafluoropropylene copolymer (FEP), and a tetrafluoroethylene-ethylene copolymer (ETFE); phenol resin; epoxy resin; silicone resin; and modified products thereof. These polymer resins can be used alone or in a mixture of two or more thereof depending on the processability and a use of the low dielectric loss resin composition. For example, when a polymer resin obtained by mixing an epoxy resin with a polyphenylene ether resin is used, processability can be improved by increasing fluidity. The polymerization degree of the polymer resin is not particularly limited, and can be appropriately selected according to a use of the low dielectric loss resin composition and the like.

The content of the polymer resin is preferably 15 mass % or more and 99 mass % or less, more preferably 18 mass % or more and 90 mass % or less, and particularly preferably 21 mass % or more and 80 mass % or less with respect to the total mass of the low dielectric loss resin composition. When the content of the polymer resin is 15 mass % or more, characteristics, such as adhesiveness and water resistance, of the polymer resin can be sufficiently exhibited. On the other hand, when the content of the polymer resin is 99 mass % or less, the dielectric loss of the resin composition can be reduced by adding the inorganic filler while the characteristics of the polymer resin are maintained.

The upper limit value of the relative permittivity εᵣ₃[-] of the low dielectric loss resin composition is preferably 6 or less, more preferably 4 or less, and particularly preferably 3.5 or less at a frequency of 1 GHz or more and a temperature of 25° C. When the relative permittivity εᵣ₃ of the low dielectric loss resin composition is 6 or less, the loss coefficient can be reduced, and the low dielectric loss can be suppressed.

The upper limit value of the dielectric loss tangent tan δ₃[-] of the low dielectric loss resin composition is preferably 0.03 or less, more preferably 0.025 or less, and particularly preferably 0.002 or less at a frequency of 1 GHz or more and a temperature of 25° C. When the dielectric loss tangent tan δ₃ of the low dielectric loss resin composition is 0.03 or less, the loss coefficient can be reduced, and the low dielectric loss can be suppressed.

The upper limit value of the loss coefficient of the low dielectric loss resin composition is preferably less than 40, more preferably 38 or less, and particularly preferably 35 or less. When the loss coefficient is less than 40, the loss coefficient of the low dielectric loss resin composition can be reduced, and the low dielectric loss characteristics can be improved.

The numerical values of the relative permittivity εᵣ₃ and the dielectric loss tangent tan δ₃ for use in quantification of the dielectric characteristics and the dielectric loss are based on a value obtained by measuring the low dielectric loss resin composition and converting the measured value. Measurement methods can be appropriately selected. Specifically, measurements can be made by methods similar to those described in Examples below.

For the loss coefficient, the value of the loss coefficient can be calculated on the basis of the following expression using the measured values of a relative permittivity εᵣ₃ and a dielectric loss tangent tan δ₃ of a low dielectric loss resin composition.

$$( Loss coefficient ) = {( {ε}_{r 3} )}^{1 / 2} \times tan {δ}_{3} \times {10}^{3}$$

wherein εᵣ₃[-] represents a relative permittivity of a low dielectric loss resin composition used in the measurement, and tan δ₃[-] represents a dielectric loss tangent of the low dielectric loss resin composition.

The relative permittivity εᵣ₃ is a parameter indicating a degree of polarization of the low dielectric loss resin composition used in measurement, and the higher the relative permittivity, the larger the propagation delay of electric signals. Therefore, the relative permittivity is preferably low from the viewpoint of increasing the propagation speed of signals. The dielectric loss tangent tan δ₃ is a parameter indicating an amount in which signals propagating through the inside of the low dielectric loss resin composition used in the measurement are lost by conversion into heat, and a decreased dielectric loss tangent leads to a reduced loss of signals, and an improved signal transmissibility.

Next, a method for producing the low dielectric loss resin composition according to the present embodiment will be described below. The low dielectric loss resin composition of the present embodiment can be produced by adding an inorganic filler, optional other additives, and the like to a polymer resin, and uniformly mixing or kneading the mixture. Alternatively, the low dielectric loss resin composition can be produced by adding an inorganic filler and optional other additives and the like to a solution (for example, a varnish or a dispersion liquid) in which a polymer resin or a monomer for forming the polymer resin is dissolved or dispersed in an organic solvent or the like, followed by dispersion.

The low dielectric loss resin composition of the present embodiment may contain impurities as long as the purpose of the present invention is not contradicted. Examples of the impurities include metal impurities, metal oxides and metal fluorides having elements other than Al and F. The content of impurities is preferably 100 ppm or less, and more preferably 10 ppm or less with respect to the total mass of the low dielectric loss resin composition.

The low dielectric loss resin composition of the present embodiment may contain other additives as long as the purpose of the present invention is not contradicted. The other additives are not particularly limited, and examples thereof include a curing agent, a slip agent, a crystal nucleating agent, an ultraviolet inhibitor, a colorant, a flame retardant, a stabilizer, a plasticizer, a strengthening agent, and a dispersant.

The content of the other additives is not particularly limited, and can be appropriately set according to a use, a purpose, and the like.

The low dielectric loss resin composition of the present embodiment can be used as, for example, a resin composition for an insulating film (solder resist), a semiconductor sealing resin composition, an adhesive, a coating material, or a covering material for wiring for power supply, communication and the like.

### (Molded Product for High-Frequency Equipment and Method for Producing Same)

The molded product for high-frequency equipment according to the present embodiment (hereinafter, referred to as a “molded product”) includes a molded product containing a low dielectric loss resin composition. The molded product may include only a low dielectric loss resin composition.

The upper limit value of the relative permittivity εᵣ₄[-] of the molded product is preferably 6 or less, more preferably 4 or less, and particularly preferably 3.5 or less at a frequency of 1 GHz or more and a temperature of 25° C. When the relative permittivity ε4 of the molded product is 6 or less, the loss coefficient can be reduced, and the dielectric loss can be reduced.

The upper limit value of the dielectric loss tangent tan δ₄[-] of the molded product is preferably 0.03 or less, more preferably 0.025 or less, and still more preferably 0.002 or less at a frequency of 1 GHz or more and a temperature of 25° C. When the dielectric loss tangent tan δ₄[-] of the molded product is 0.03 or less, the loss coefficient can be reduced, and the dielectric loss can be reduced.

The upper limit value of the loss coefficient of the molded product is preferably less than 40, more preferably 38 or less, and particularly preferably 35 or less. When the loss coefficient is less than 40, the loss coefficient of the molded product can be reduced, and the dielectric loss can be reduced.

The numerical values of the relative permittivity εᵣ₄ and the dielectric loss tangent tan δ₄ for use in quantification of the dielectric characteristics and the dielectric loss are based on a value obtained by measuring the molded product and converting the measured value. Measurement methods can be appropriately selected. Specifically, measurements can be made by the methods described in Examples below.

The loss coefficient can be calculated on the basis of the following expression using the measured values of a relative permittivity εᵣ₄ and a dielectric loss tangent tan δ₄ of a molded product.

(Loss coefficient)=(εᵣ₄)^{1/2}×tan δ₄×10³

wherein εᵣ₄[-] represents a relative permittivity of a molded product, and tan δ₄[-] represents a dielectric loss tangent of the molded product.

The molded product can be produced by using, for example, a known kneader and extruder. As the kneader, for example, a sealed pressure kneader or an open roll can be used. A sheet-shaped low dielectric loss resin composition material can be produced using any of these kneaders, followed by production of a molded product using the low dielectric loss resin composition material. A pellet-shaped low dielectric loss resin composition material can be produced with an extruder, followed by production of a molded product using an injection molding machine. When the polymer resin is mixed with the inorganic filler, other additives and the like using a molding machine such as an extruder, the number of processes can be reduced, so that production efficiency can be improved. Since the inorganic filler is likely to adsorb moisture, drying treatment or the like may be appropriately performed before mixing with the polymer resin.

When a sheet-shaped molded product is produced, a known method can be used for the production. For example, to a varnish tank filled with a solution containing a polymer resin (resin varnish) are added an inorganic filler, optional other additives and the like, which are uniformly dispersed, and the dispersion liquid is heated under a predetermined temperature condition. The cured product produced by heating is stretched into a sheet shape, whereby a sheet-shaped molded product can be produced.

A sheet-shaped substrate such as a glass cloth or a bonding sheet is made to pass through a liquid bath with a dispersion liquid containing a polymer resin, an inorganic filler, optional other additives and the like with the sheet-shaped substrate immersed in the liquid tank, thereby impregnating the sheet-shaped substrate with the dispersion liquid. Thereafter, drying treatment is performed on the sheet impregnated with the dispersion liquid, whereby an impregnated sheet impregnated with a low dielectric loss resin composition can be produced. A laminate in which a plurality of low dielectric loss resin composition layers are laminated can also be produced by making the sheet-shaped substrate pass through the liquid tank with a dispersion liquid a plurality of times.

### (High-Frequency Equipment)

High-frequency equipment according to the present embodiment includes a low dielectric loss resin composition or a molded product of a low dielectric loss resin composition.

The high-frequency equipment of the present embodiment is used for information processing and information communication performed by electronically exchanging signals. In particular, the high-frequency equipment of the present embodiment is used in a high-frequency band in which a frequency band of a radio wave or signals used during communication is 1 GHz or more, and more preferably 10 GHz or more. The high-frequency equipment of the present embodiment also includes high-frequency electronic components used in such a high-frequency band.

Examples of the high-frequency equipment include housings for information processing and information communication equipment, circuit boards, printed circuit boards, transmission lines, high-frequency electronic components such as capacitors and inductors, and ceiling materials and wall materials for a room in which high-frequency equipment is installed. The high-frequency equipment of the present embodiment also includes high-frequency equipment including an insulating film formed from a low dielectric loss resin composition, a semiconductor sealing resin, wiring covered with a low dielectric loss resin composition as a covering material, and the like.

### EXAMPLES

Hereinafter, preferred examples of the present invention will be described in detail for illustrative purposes. However, materials, blending amounts and the like described in the examples are not intended to limit the scope of the present invention thereto unless placement of a limitation is indicated.

### (α-AlF₃(A))

α-AlF₃(A) manufactured by STELLA CHEMIFA CORPORATION was used. For the powdered α-AlF₃(A), the half-width of a peak on the (012) plane in an X-ray diffraction pattern was measured. For the measurement, an X-ray diffractometer (trade name: RINT-ULTIMA, manufactured by Rigaku Corporation) was used. The measurement conditions were as follows.
X-ray tube: Cu
Tube voltage: 40 kV
Tube current: 40 mA
Step size (width): 0.020
Measurement range (scanning range of diffraction angles): 2θ=10° to 70°

The half-width was calculated from a diffraction intensity peak corresponding to the (012) plane of α-AlF₃ and appearing around 2θ=25.3°. As a result, the half-width of α-AlF₃(A) was shown to be 0.162°.

Subsequently, the average particle size D50 of α-AlF₃(A) was measured. First, powdered α-AlF₃(A) was added in an amount of 0.1 to 0.3 g inclusive to 200 mL of a circulating solvent (water) flowing through the inside of a particle size distribution measuring apparatus (trade name: Microtrac MT3300EXII, manufactured by Nikkiso Co., Ltd.). In this way, an aqueous dispersion liquid having an α-AlF₃(A) concentration of 0.05 to 0.15 mass % inclusive with respect to the total mass was prepared, and a laser diffraction and scattering method was applied to the aqueous dispersion liquid to perform measurement. In the obtained particle size distribution, an average particle size corresponding to a cumulative volume of 50% was calculated as D50. As a result, α-AlF₃(A) was shown to have an average particle size D50 of 9.3 m, and confirmed to be suitable for a film-shaped or sheet-shaped molded article of a low dielectric loss resin composition having a thickness of, for example, about 20 μm.

Further, the oxygen content of the inorganic filler was measured using, for example, an X-ray fluorescence spectrometer (trade name: ZSX Primus II, manufactured by Rigaku Corporation). As a result, the oxygen content of α-AlF₃(A) was 0.2 mass % with respect to the total mass of α-AlF₃(A).

### (α-AlF₃(B))

α-AlF₃(B) manufactured by STELLA CHEMIFA CORPORATION was used. For the powdered α-AlF₃(B), the half-width of a peak on the (012) plane in the X-ray diffraction pattern, the average particle size D50, and the oxygen content of α-AlF₃(B) were measured in the same manner as in the case of α-AlF₃(A). The result of the measurement showed that the half-width of α-AlF₃(B) was 0.165°. In addition, α-AlF₃(B) had an average particle size D50 of 4.6 μm, and was confirmed to be suitable for a film-shaped or sheet-shaped molded article of a low dielectric loss resin composition having a thickness of, for example, about 20 μm. Further, the oxygen content was 0.4 mass % with respect to the total mass of α-AlF₃(B).

### (α-AlF₃(C))

α-AlF₃(C) manufactured by STELLA CHEMIFA CORPORATION was used. For the powdered α-AlF₃(C), the half-width of a peak on the (012) plane in the X-ray diffraction pattern, the average particle size D50, and the oxygen content of α-AlF₃(C) were measured in the same manner as in the case of α-AlF₃(A). The result of the measurement showed that the half-width of α-AlF₃(C) was 0.169°. In addition, α-AlF₃(C) had an average particle size D50 of 2.7 μm, and was confirmed to be suitable for a film-shaped or sheet-shaped molded article of a low dielectric loss resin composition having a thickness of, for example, about 20 μm. Further, the oxygen content was 0.4 mass % with respect to the total mass of α-AlF₃(C).

### (α-AlF₃(D))

For the powdered α-AlF₃(D), the half-width of a peak on the (012) plane in the X-ray diffraction pattern, the average particle size D50, and the oxygen content of α-AlF₃(D) were measured in the same manner as in the case of α-AlF₃(A). The result of the measurement showed that the half-width of α-AlF₃(D) was 0.176°. The average particle size D50 of α-AlF₃(D) was 72 μm. Further, the oxygen content was 0.9 mass % with respect to the total mass of α-AlF₃(D).

### (α-AlF₃(E))

α-AlF₃(E) manufactured by STELLA CHEMIFA CORPORATION was used. For the powdered α-AlF₃(E), the half-width of a peak on the (012) plane in the X-ray diffraction pattern, the average particle size D50, and the oxygen content of α-AlF₃(E) were measured in the same manner as in the case of α-AlF₃(A). The result of the measurement showed that the half-width of α-AlF₃(E) was 0.187°. In addition, α-AlF₃(E) had an average particle size D50 of 2.3 μm, and was confirmed to be suitable for a film-shaped or sheet-shaped molded article of a low dielectric loss resin composition having a thickness of, for example, about 20 μm. Further, the oxygen content was 1.0 mass % with respect to the total mass of α-AlF₃(E).

### (α-AlF₃(F))

α-AlF₃(F) manufactured by STELLA CHEMIFA CORPORATION was used. For the powdered α-AlF₃(F), the half-width of a peak on the (012) plane in the X-ray diffraction pattern, the average particle size D50, and the oxygen content of α-AlF₃(F) were measured in the same manner as in the case of α-AlF₃(A). The result of the measurement showed that the half-width of α-AlF₃(F) was 0.290°. The average particle size D50 of α-AlF₃(F) was 70 μm. Further, the oxygen content was 1.3 mass % with respect to the total mass of α-AlF₃(F).

### (α-AlF₃(G))

For the powdered α-AlF₃(G), the half-width of a peak on the (012) plane in the X-ray diffraction pattern, the average particle size D50, and the oxygen content of α-AlF₃(G) were measured in the same manner as in the case of α-AlF₃(A). The result of the measurement showed that the half-width of α-AlF₃(G) was 0.304°. The average particle size D50 of α-AlF₃(G) was 82 μm. Further, the oxygen content was 2.1 mass % with respect to the total mass of α-AlF₃(G).

### (β-AlF₃(H))

An alumina crucible was filled with 50 g of (NH₄)₃AlF₆ (manufactured by STELLA CHEMIFA CORPORATION), on which heating treatment was performed in an air atmosphere using an electric furnace. The heat treatment temperature was 400° C., and the heat treatment time was 6 hours. After the heating treatment, the alumina crucible was allowed to cool to room temperature, and 22 g of a white powder was taken out from the alumina crucible. The white powder was analyzed by XRD (X-ray diffraction, trade name: RINT-Ultima III, manufactured by Rigaku Corporation), and the result showed that the white powder was β-AlF₃.

For the obtained β-AlF₃(H), the average particle size D50 and the oxygen content of β-AlF₃(H) were measured in the same manner as in the case of α-AlF₃(A). The result of the measurement showed that the average particle size D50 of β-AlF₃(H) was 21 μm. The oxygen content was 3.5 mass % with respect to the total mass of β-AlF₃(H).

### (α-AlF₃(I))

For the powdered α-AlF₃(I), the half-width of a peak on the (012) plane in the X-ray diffraction pattern, and the average particle size D50 were measured in the same manner as in the case of α-AlF₃(A). The result of the measurement showed that the half-width of α-AlF₃(I) was 0.190°. The average particle size D50 of α-AlF₃(I) was 54 m.

### (α-AlF₃(J))

For the powdered α-AlF₃(J), the half-width of a peak on the (012) plane in the X-ray diffraction pattern, and the average particle size D50 were measured in the same manner as in the case of α-AlF₃(A). The result of the measurement showed that the half-width of α-AlF₃(J) was 0.260°. The average particle size D50 of α-AlF₃(J) was 74 m.

### (α-AlF₃(K))

For the powdered α-AlF₃(K), the half-width of a peak on the (012) plane in the X-ray diffraction pattern, the average particle size D50, and the oxygen content of α-AlF₃(K) were measured in the same manner as in the case of α-AlF₃(A). The result of the measurement showed that the half-width of α-AlF₃(K) was 0.127°. The average particle size D50 of α-AlF₃(K) was 45 μm. Further, the oxygen content was 0.7 mass % with respect to the total mass of α-AlF₃(K).

### Example 1

A quartz tube was filled with powder of α-AlF₃(K) having a half-width of 0.127° as an inorganic filler, and the relative permittivity and the dielectric loss tangent were measured in an environmental atmosphere at a temperature of 19° C. and a relative humidity of 50% by a cavity resonator method at a frequency region of 10 GHz. For the measurement, a vector network analyzer (manufactured by ANRITSU CORPORATION, trade name: MS46122B) was used. Thereafter, the relative permittivity and the dielectric loss tangent of the quartz tube filled with the inorganic filler were corrected for void portions using the bulk density and the true density of the inorganic filler and the filling content of the inorganic filler relative to the filling capacity, followed by calculation of the relative permittivity and the dielectric loss tangent of the inorganic filler. Further, using the corrected measured values of the relative permittivity and dielectric loss tangent of the inorganic filler, the dielectric loss of the inorganic filler was calculated on the basis of the following expression. The results are shown in Table 1. The values of the relative permittivity and dielectric loss tangent of the inorganic filler in Table 1 are values obtained by correcting the measured values.

$$( Loss coefficient ) = {( {ε}_{r 1} )}^{1 / 2} \times tan {δ}_{1} \times {10}^{3}$$

wherein εᵣ₁ represents a relative permittivity of the inorganic filler, and tan δ₁ represents a dielectric loss tangent of the inorganic filler.

### Examples 2 to 7

In Examples 2 to 7, the inorganic filler was changed to those shown in Table 1. Except for the above, the same procedure as in Example 1 was carried out to perform measurement.

### Comparative Examples 1 and 2

In Comparative Examples 1 and 2, the inorganic filler was changed to those shown in Table 1. Except for the above, the same procedure as in Example 1 was carried out to perform measurement.

TABLE 1

| | | | | | Loss | Average | |
|---|---|---|---|---|---|---|---|
| | | | Relative | Dielectric | coefficient | particle | Oxygen |
| | Inorganic | Half width | permittivity | loss tangent | εᵣ₁^{1/2} × tanδ₁ | size | content |
| | filler | (deg) | εᵣ₁[—] | tanδ₁[—] | [—, × 10³][—] | D50(μm) | (O mass %) |
| Example 1 | α-AlF₃(K) | 0.127 | 3.5 | 0.0007 | 0.3 | 45 | 0.7 |
| Example 2 | α-AlF₃(A) | 0.162 | 3.1 | 0.0011 | 1.9 | 9.3 | 0.2 |
| Example 3 | α-AlF₃(B) | 0.165 | 3.2 | 0.0020 | 3.6 | 4.6 | 0.4 |
| Example 4 | α-AlF₃(C) | 0.169 | 3.1 | 0.0039 | 6.9 | 2.7 | 0.4 |
| Example 5 | α-AlF₃(D) | 0.176 | 3.2 | 0.0047 | 8.4 | 72 | 0.9 |
| Example 6 | α-AlF₃(E) | 0.187 | 3.1 | 0.0078 | 14 | 2.3 | 1.0 |
| Example 7 | α-AlF₃(F) | 0.290 | 3.4 | 0.0044 | 8.0 | 70 | 1.3 |
| Comparative | α-AlF₃(G) | 0.304 | 3.5 | 0.0270 | 51 | 82 | 2.1 |
| Example 1 | | | | | | | |
| Comparative | β-AlF₃(H) | — | 3.4 | 0.0136 | 25 | 21 | 3.5 |
| Example 2 | | | | | | | |

### (Result 1)

As shown in Table 1, it was confirmed that as compared to the inorganic fillers used in Comparative Examples 1 and 2, the inorganic fillers of Examples 1 to 7 had a smaller loss coefficient measured at the same frequency, and were superior in low dielectric loss characteristics. Accordingly, AlF₃ having an α phase was confirmed to have excellent low dielectric loss characteristics when the half-width on the (012) plane was in the range of 0.12° or more and 0.3° or less in the context of crystallinity and average particle size. It was confirmed that as compared to the inorganic fillers used in Comparative Examples 1 and 2, the inorganic fillers of Examples 1 to 7 had a smaller oxygen content value, and all had a reduced value of tan δ as a dielectric loss tangent.

### Example 8

A container cup was charged with 80.0 g of α-AlF₃(B) as an inorganic filler and 120 g of n-hexadecane (special grade chemical, manufactured by FUJIFILM Wako Pure Chemical Corporation), and the mixture was stirred with a homogenizer to prepare a slurry composition.

Next, the prepared slurry composition was poured into a PFA heat-shrinkable tube (8 cm in length, 2.2 mm in outer diameter and inner diameter: 1.8 mm) using a syringe or the like, which was sealed with a PFA rod (2 mm in diameter) to prevent leakage of the slurry composition, followed by heating with a hot air dryer. Thus, a test piece including the slurry composition of the present example was prepared.

Subsequently, the relative permittivity and the dielectric loss tangent of the slurry composition in the obtained test piece were measured in an environmental atmosphere at a temperature of 19° C. and a relative humidity of 50% by a cavity resonator method at a frequency region of 10 GHz. For the measurement, a network analyzer (manufactured by Keysight Technologies, trade name: E8361A) was used. Using the measured values of the relative permittivity and dielectric loss tangent of the slurry of an inorganic filler, the loss coefficient of the slurry composition was calculated on the basis of the following expression. The results are shown in Table 2.

$$( Loss coefficient ) = {( {ε}_{r 2} )}^{1 / 2} \times tan {δ}_{2} \times {10}^{3}$$

wherein εᵣ₂ represents a relative permittivity of a slurry composition, and tan δ₂ represents a dielectric loss tangent of the slurry composition.

### Example 9

In Example 9, the inorganic filler was changed to α-AlF₃(I) having a half-width of 0.190 as shown in Table 2. Except for the above, the same procedure as in Example 8 was carried out to prepare a test piece according to Example 9. Further, for the test piece according to Example 9, the same procedure as in Example 8 was carried out to measure the relative permittivity and the dielectric loss tangent, and calculate the loss coefficient. The results are shown in Table 2.

### Comparative Examples 3 and 4

As shown in Table 2, the inorganic fillers were changed to α-AlF₃(G) having a half-value width of 0.304 and β-AlF₃(H) having a 3 phase in Comparative Examples 3 and 4, respectively. Except for the above, the same procedure as in Example 8 was carried out to prepare test pieces according to Comparative Examples 3 and 4. Further, for the test piece according to each of Comparative Examples 3 and 4, the same procedure as in Example 8 was carried out to measure the relative permittivity and the dielectric loss tangent, and calculate the loss coefficient. The results are shown in Table 2.

TABLE 2

| | | | | | Loss | |
|---|---|---|---|---|---|---|
| | | | Relative | Dielectric | coefficient | Average |
| | Inorganic | Half width | permittivity | loss tangent | εᵣ₂^{1/2} × tanδ₂ | particle size |
| | filler | (deg) | εᵣ₂[—] | Tanδ₂[—] | [—, × 10³][—] | D50(μm) |
| Example 8 | α-AlF₃(B) | 0.165 | 2.2 | 0.0009 | 1.3 | 4.6 |
| Example 9 | α-AlF₃(I) | 0.190 | 1.9 | 0.0017 | 2.3 | 54 |
| Comparative | α-AlF₃(G) | 0.304 | 2.2 | 0.0051 | 7.6 | 82 |
| Example 3 | | | | | | |
| Comparative | β-AlF₃(H) | — | 1.9 | 0.0035 | 4.8 | 21 |
| Example 4 | | | | | | |

### (Result 2)

As shown in Table 2, it was confirmed that as compared to the slurry compositions used in Comparative Examples 3 and 4, the slurry compositions of Examples 8 and 9 had a smaller loss coefficient measured at the same frequency, and were superior in low dielectric loss characteristics.

### Example 10 (Preparation of Test Piece Using Epoxy Resin)

A container cup was charged with 10 g of an epoxy resin (trade name: jER (registered trademark) 828, manufactured by Mitsubishi Chemical Corporation), 5 g of an epoxy resin curing agent (trade name: jER CURE (registered trademark), manufactured by Mitsubishi Chemical Corporation) and 15 g of α-AlF₃(A) as an inorganic filler, and the mixture was kneaded with a defoaming stirrer to prepare a paste.

The prepared paste was placed in a mold, allowed to cure at room temperature for 1 day, and then cured by heating at 80° C. for 3 hours. Thereafter, the cured product was taken out from the mold to prepare a molded product of a low dielectric loss resin composition (inorganic-organic composite test piece) according to Example 10.

Subsequently, the relative permittivity and the dielectric loss tangent of the obtained molded product were measured in an environmental atmosphere at a temperature of 19° C. and a relative humidity of 50% by a cavity resonator method at a frequency region of 10 GHz. For the measurement, a network analyzer (trade name: E8361A, manufactured by Keysight Technologies) was used. Further, the loss coefficient of the molded product was calculated on the basis of the following expression. The results are shown in Table 3.

$$( Loss coefficient ) = {( {ε}_{r 4} )}^{1 / 2} \times tan {δ}_{4} \times {10}^{3}$$

wherein εᵣ₄ represents a relative permittivity of a molded product, and tan δ₄ represents a dielectric loss tangent of the molded product.

### Examples 11 to 15 (Preparation of Test Piece Using Epoxy Resin)

In Examples 11 to 15, the inorganic filler was changed to those shown in Table 3. Except for the above, the same procedure as in Example 10 was carried out to prepare a molded product of a low dielectric loss resin composition according to each of Examples 11 to 15. Further, for the molded product according to each of Examples 11 to 15, the same procedure as in Example 10 was carried out to measure the relative permittivity and the dielectric loss tangent, and calculate the loss coefficient. The results are shown in Table 3.

### Comparative Examples 5 to 7 (Preparation of Test Piece Using Epoxy Resin)

In Comparative Examples 5 and 6, the inorganic filler was changed to those shown in Table 3. In Comparative Example 7, an inorganic filler was not used. Except for the above, the same procedure as in Example 10 was carried out to prepare a molded product of a low dielectric loss resin composition according to each of Comparative Examples 5 to 7. Further, for the molded product according to each of Comparative Examples 5 to 7, the same procedure as in Example 10 was carried out to measure the relative permittivity and the dielectric loss tangent, and calculate the loss coefficient. The results are shown in Table 3.

TABLE 3

| | | | | | Loss | |
|---|---|---|---|---|---|---|
| | | | | | coefficient | |
| | | | Relative | Dielectric | εᵣ₄^{1/2} × tanδ₄ | Average |
| | Inorganic | Half width | permittivity | loss tangent | [—, × 10³][—] | particle size |
| | filler | (deg) | εᵣ₄ [—] | Tanδ₄ [—] | Loss | D50(μm) |
| Example 10 | α-AlF₃(A) | 0.162 | 3.4 | 0.017 | 32 | 9.3 |
| Example 11 | α-AlF₃(B) | 0.165 | 3.4 | 0.017 | 32 | 4.6 |
| Example 12 | α-AlF₃(C) | 0.169 | 3.3 | 0.017 | 32 | 2.7 |
| Example 13 | α-AlF₃(D) | 0.176 | 3.3 | 0.017 | 32 | 72 |
| Example 14 | α-AlF₃(E) | 0.187 | 3.5 | 0.018 | 34 | 2.3 |
| Example 15 | α-AlF₃(J) | 0.260 | 3.4 | 0.019 | 36 | 74 |
| Comparative | α-AlF₃(G) | 0.304 | 3.3 | 0.022 | 40 | 82 |
| Example 5 | | | | | | |
| Comparative | β-AlF₃(H) | — | 3.2 | 0.024 | 43 | 21 |
| Example 6 | | | | | | |
| Comparative | — | — | 3.0 | 0.026 | 45 | — |
| Example 7 | | | | | | |

### (Result 3)

As shown in Table 3, it was confirmed that as compared to the molded products of Comparative Examples 5 to 7, molded products composed of the low dielectric loss resin compositions of Examples 10 to 15 had a smaller loss coefficient measured at the same frequency, and were superior in low dielectric loss characteristics. Accordingly, AlF₃ having an α phase was confirmed to have excellent low dielectric loss characteristics when the half-width on the (012) plane was in the range of 0.12° or more and 0.3° or less in the context of crystallinity and average particle size.

1. An inorganic filler for a low dielectric loss resin composition,
wherein the inorganic filler
is in a powder form, and
contains aluminum fluoride having an α phase, and
a half width of a peak on a (012) plane of an α phase of the aluminum fluoride in an X-ray diffraction pattern is 0.3° or less.

2. The inorganic filler for a low dielectric loss resin composition according to claim 1, wherein the half width is 0.120 or more.

3. The inorganic filler for a low dielectric loss resin composition according to claim 1, wherein an average particle size D50 of the inorganic filler is 0.05 μm or more and 75 μm or less.

4. The inorganic filler for a low dielectric loss resin composition according to claim 1, wherein an oxygen content of the inorganic filler is 2 mass % or less with respect to a total mass of the inorganic filler.

5. A slurry composition for a low dielectric loss resin composition in which an inorganic filler is dispersed in a solvent,
wherein the inorganic filler contains aluminum fluoride having an α phase, and
a half width of a peak on a (012) plane of an α phase of the aluminum fluoride in an X-ray diffraction pattern is 0.3° or less.

6. The slurry composition for a low dielectric loss resin composition according to claim 5, wherein the half width is 0.12° or more.

7. The slurry composition for a low dielectric loss resin composition according to claim 5, wherein an average particle size D50 of the inorganic filler is 0.05 μm or more and 75 μm or less.

8. The slurry composition for a low dielectric loss resin composition according to claim 5, wherein an oxygen content of the inorganic filler is 2 mass % or less with respect to a total mass of the inorganic filler.

9. The slurry composition for a low dielectric loss resin composition according to claim 5, wherein a content of the inorganic filler is 1 mass % or more and 85 mass % or less with respect to a total mass of the slurry composition for a low dielectric loss resin composition.

10. A low dielectric loss resin composition comprising at least a polymer resin and an inorganic filler,
wherein the inorganic filler contains aluminum fluoride having an α phase, and
a half width of a peak on a (012) plane of an α phase of the aluminum fluoride in an X-ray diffraction pattern is 0.3° or less.

11. The low dielectric loss resin composition according to claim 10, wherein the half width is 0.120 or more.

12. The low dielectric loss resin composition according to claim 10, wherein an average particle size D50 of the inorganic filler is 0.05 μm or more and 75 μm or less.

13. The low dielectric loss resin composition according to claim 10, wherein an oxygen content of the inorganic filler is 2 mass % or less with respect to a total mass of the inorganic filler.

14. The low dielectric loss resin composition according to claim 10, wherein a content of the inorganic filler is 1 mass % or more and 85 mass % or less with respect to a total mass of the low dielectric loss resin composition.

15. The low dielectric loss resin composition according to claim 10, wherein the polymer resin contains at least one thermoplastic resin and/or at least one thermosetting resin.

16. The low dielectric loss resin composition according to claim 15, wherein the polymer resin is at least one selected from a group consisting of olefin-based resin, polycarbonate resin, polyphenylene ether resin, polysulfone resin, polyether sulfone resin, polyphenylene sulfide resin, polyether ether ketone resin, liquid crystal polymer resin, polyimide resin, fluororesin, phenol resin, epoxy resin, silicone resin, and a modified product thereof.

17. A molded product for high-frequency equipment used in a frequency band of 1 GHz or more, the molded product comprising a molded product containing the low dielectric loss resin composition according to claim 10.

18. High-frequency equipment used in a frequency band of 1 GHz or more, the high-frequency equipment comprising the low dielectric loss resin composition according to claim 10.

19. High-frequency equipment used in a frequency band of 1 GHz or more, the high-frequency equipment comprising the molded product for high-frequency equipment according to claim 17.
